(19) United States
(12) Patent Application Publication
(10) Pub. No.: US 2011/0154049 A1
(43) Pub. Date: Jun. 23, 2011

(54) SYSTEM AND METHOD FOR PERFORMING DATA BACKUP OF DIGITAL VIDEO RECORDER

(75) Inventor: Ming-Chih Hsieh, Tu-Cheng (TW)

(73) Assignee: HON HAI PRECISION INDUSTRY CO., LTD., Tu-Cheng (TW)

(21) Appl. No.: 12/795,835

(22) Filed: Jun. 8, 2010

(30) Foreign Application Priority Data
Dec. 18, 2009 (CN) 200910311857.4

(51) Int. Cl. G06F 12/16; G06F 12/14; G06F 12/00

(52) U.S. Cl. 713/185; 711/162; 711/154; 711/E12.001; 711/E12.103

(57) ABSTRACT

A system and method for performing data backup of a digital video recorder determines if a second safe mechanism key stored in a secure digital (SD) card is valid when the SD card is detected by the digital video recorder, and changes a data storage path from a first hard disk of the digital video recorder to the SD card if the safe mechanism key stored in the SD card is valid. The system and method further changes the data storage path from the SD card to a second hard disk when the second hard disk is installed, and copies backup data stored in the SD card to the second hard disk.

### BACKGROUND

1. Technical Field

Embodiments of the present disclosure relate to data managing technology, and particularly to a system and a method for performing data backup of a digital video recorder.

2. Description of Related Art

Currently, a digital video recorder (DVR) is used to perform security surveillance by capturing images of specified location, and storing the captured images onto a hard disk. The hard disk of the DVR needs to be replaced with a new one if storage space of the hard disk is full. Often, a secure digital (SD) card is used to store backup data when the new hard disk is installed. However, the current method does not perform an identity verification of the SD card. It may be dangerous because anyone can obtain the backup data using the SD card without verifying the validity of the inserted SD card.

What is needed, therefore, is an improved system and method for performing data backup of a DVR.

### BRIEF DESCRIPTION OF THE DRAWINGS

FIG. 1 is a block diagram of one embodiment of a digital video recorder comprising a data backup system.

FIG. 2 is a schematic diagram of one embodiment of an SD card.

FIG. 3 is a block diagram of one embodiment of a data backup system of FIG. 1.

FIG. 4 is a flowchart of one embodiment of a method for performing data backup of the digital video recorder.

### DETAILED DESCRIPTION

All of the processes described below may be embodied in, and fully automated through, functional code modules executed by one or more general purpose computers or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

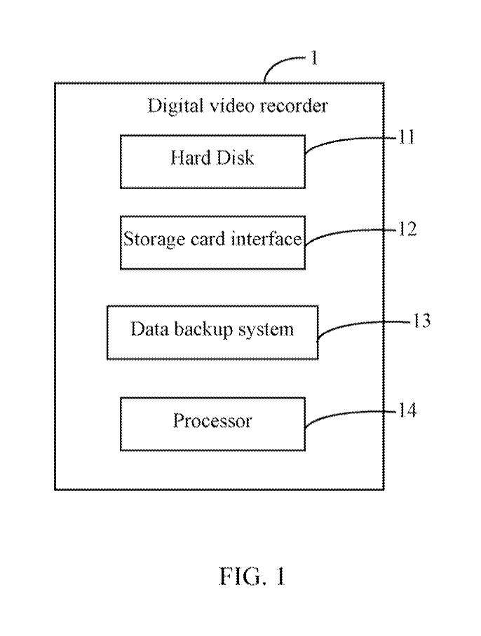

FIG. 1 is a block diagram of one embodiment of a digital video recorder (DVR) 1 comprising a data backup system 13. In one embodiment, the data backup system 13 may be used to automatically verify an identity of a secure digital (SD) card inserted in the DVR 1, and perform data backup operation using the SD card if the SD card passes the verification. A detailed description will be given in the following paragraphs.

In one embodiment, the DVR 1 may further include a hard disk 11 (hereinafter referred to as “the first hard disk 11”), a storage card interface 12, and a processor 14. The first hard disk 11 may be used to store a first safe mechanism key and captured video data of the DVR 1. In one embodiment, the first safe mechanism key includes an identification code and a cryptograph of the DVR 1. The storage card interface 12 may be used to connect external storage devices, such as the SD card or other suitable memory storage devices.

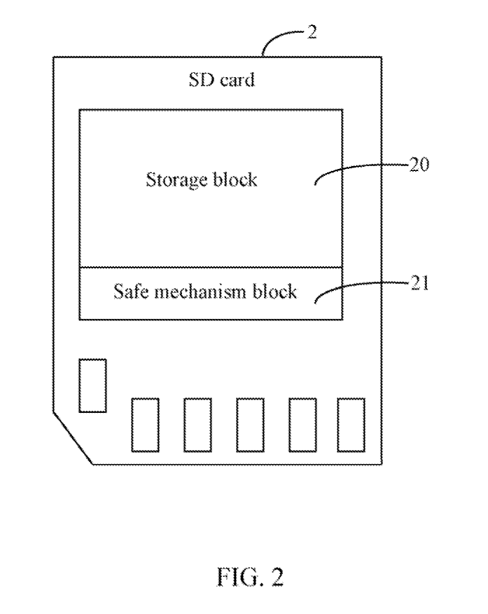

FIG. 2 is a schematic diagram of one embodiment of an SD card 2. In one embodiment, the SD card 2 includes a storage block 20, and a safe mechanism block 21. In one embodiment, the storage block 20 is a first data storage location of the SD card 2, and the safe mechanism block 21 is a second data storage location of the SD card 2. For example, the storage block 20 may be used to store video data when the first hard disk 11 of the DVR 1 is hot swapped. The safe mechanism block 21 may be used to store a second safe mechanism key to verify the identity of the SD card 2. In one embodiment, if the second safe mechanism key stored in the SD card 2 is the same as the first safe mechanism key stored in the DVR 1, the SD card 2 is qualified to store the video data of the DVR 1. If the second safe mechanism key stored in the SD card 2 is not the same as the first safe mechanism key stored in the DVR 1, the SD card 2 is unqualified to store the video data of the DVR 1.

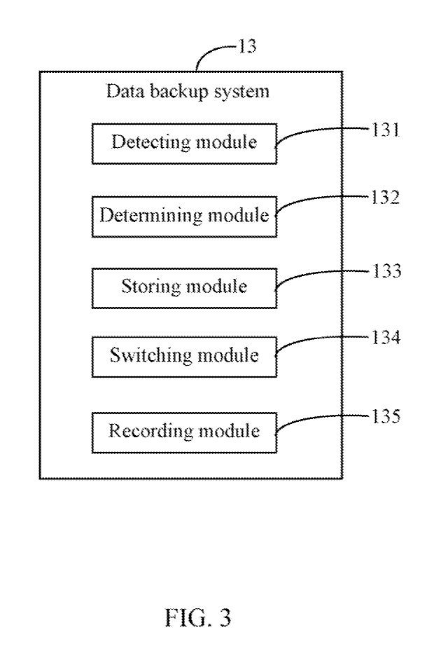

FIG. 3 is a block diagram of one embodiment of the data backup system 13 of FIG. 1. In one embodiment, the data backup system 13 includes a detecting module 131, a determining module 132, a storing module 133, a switching module 134, and a recording module 135. In one embodiment, the modules 131-135 comprise one or more computerized instructions that are stored in the DVR 1. The processor 14 of the DVR 1 executes the computerized instructions to implement one or more operations of the DVR 1.

The detecting module 131 detects if the SD card 2 is inserted in the storage card interface 12 of the DVR 1.

The determining module 132 determines if the second safe mechanism key stored in the safe mechanism block 21 of the SD card 2 is valid when the SD card 2 is detected by the detecting module 131. In one embodiment, if the second safe mechanism key stored in the safe mechanism block 21 of the SD card 2 is the same as the first safe mechanism key stored in the first hard disk 11 of DVR 1, the determining module 132 determines that the second safe mechanism key stored in the safe mechanism block 21 of the SD card 2 is valid. If the second safe mechanism key stored in the safe mechanism block 21 of the SD card 2 is not the same as the first safe mechanism key stored in the first hard disk 11 of DVR 1, the determining module 132 determines that the safe mechanism key stored in the safe mechanism block 21 of the SD card 2 is not valid.

If there is no SD card 2 detected by the detecting module 131, or the safe mechanism key stored in the safe mechanism block 21 of the SD card 2 is not valid, the storing module 133 stores video data on the first hard disk 11 of the DVR 1.

If the second safe mechanism key stored in the SD card 2 is valid, the switching module 134 changes a data storage path from the first hard disk 11 of the DVR 1 to the safe mechanism block 21 of the SD card 2. Then, another hard disk (hereinafter referred to as “the second hard disk”) may be installed in the DVR 1 using a hot swapping function. The SD card 2 may be used to store backup data of the DVR 1 when the first hard disk 11 is taken out.

The switching module 134 further changes the data storage path from the safe mechanism block 21 of the SD card 2 to the second hard disk when the second hard disk is installed.

The storing module 133 copies the backup data stored in the safe mechanism block 21 of the SD card 2 to the second hard disk.

The recording module 135 records replacement times of hot swapping hard disks after the backup data stored in the SD card 2 are copied to the second hard disk. For example, it is supposed that a “counter” represents a number of the replacement times of the hard disk. For the purpose of illustration, an initial value of the “counter” is equal to zero. When the second hard disk is installed in the DVR 1, the “counter” is evaluated as “counter+1” (counter=counter+1).

The switching module 134 further displays a message to prompt a user to take the SD card 2 out through different lighting modes of light emitting diodes (LEDs) if the replacement times are recorded.

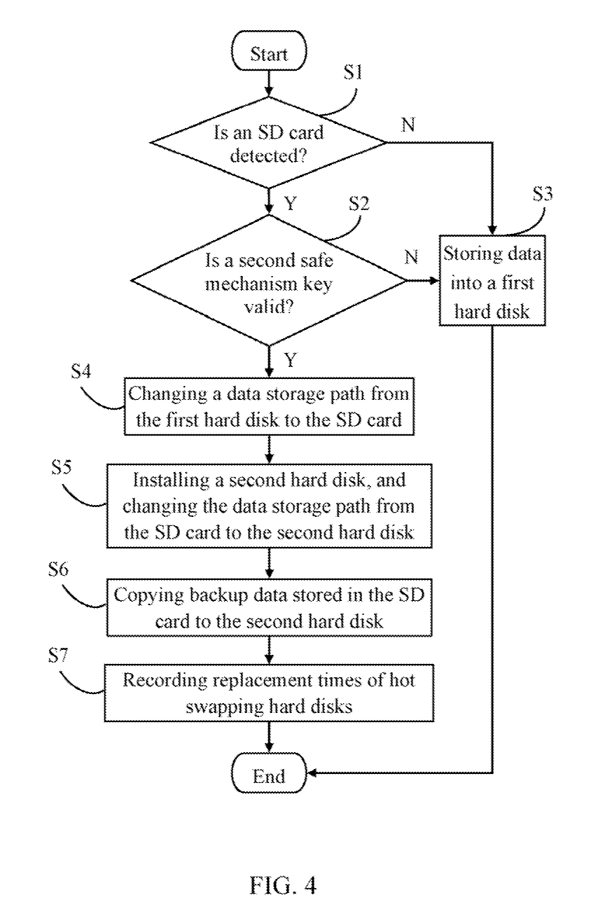

FIG. 4 is a flowchart of one embodiment of a method for performing data backup of the DVR 1. Depending on the embodiment, additional blocks may be added, others removed, and the ordering of the blocks may be changed.

In block S1, the detecting module 131 detects if the SD card 2 is inserted in the storage card interface 12 of the DVR 1. If the SD card 2 is detected, the procedure goes to block S2. If the SD card 2 is not detected, the procedure goes to block S3.

In block S2, the determining module 132 determines if the second safe mechanism key stored in the safe mechanism block 21 of the SD card 2 is valid. If the second safe mechanism key stored in the safe mechanism block 21 of the SD card 2 is valid, the procedure goes to block S4. If the second safe mechanism key stored in the safe mechanism block 21 of the SD card 2 is not valid, the procedure goes to block S3.

In block S3, the storing module 133 stores video data into the first hard disk 11 of the DVR 1.

In block S4, the switching module 134 changes a data storage path from the first hard disk 11 of the DVR 1 to the safe mechanism block 21 of the SD card 2 if the second safe mechanism key stored in the SD card 2 is valid. Then, a second hard disk may be installed in the DVR 1 using a hot swapping function. The SD card 2 may used to store backup data of the DVR 1 when the first hard disk 11 is taken out.

In block S5, the switching module 134 changes the data storage path from the safe mechanism block 21 of the SD card 2 to the second hard disk when the second hard disk is installed.

In block S6, the storing module 133 copies the backup data stored in the safe mechanism block 21 of the SD card 2 to the second hard disk.

In block S7, the recording module 135 records replacement times of hot swapping hard disks after the backup data stored in the SD card 2 are copied to the second hard disk. Then, the switching module 134 displays a message to prompt a user to take the SD card 2 out through different lighting modes of light emitting diodes (LEDs) if the replacement times are recorded.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A data backup method of a digital video recorder, comprising:
determining if a second safe mechanism key stored in a secure digital (SD) card is the same as a first safe mechanism key stored in the digital video recorder when the SD card is inserted in the digital video recorder;
changing a data storage path from a first hard disk of the digital video recorder to the SD card if the second safe mechanism key stored in the SD card is the same as the first safe mechanism key stored in the digital video recorder;
changing the data storage path from the SD card to a second hard disk when the second hard disk is installed in the digital video recorder; and
copying backup data stored in the SD card to the second hard disk.

2. The method according to claim 1, wherein the safe mechanism key comprises an identification code and a cryptograph of the digital video recorder.

3. The method according to claim 1, further comprising:
storing data into the first hard disk of the digital video recorder under the condition that the SD card is not detected by the digital video recorder, or the second safe mechanism key stored in the SD card is not the same as the first safe mechanism key stored in the digital video recorder.

4. The method according to claim 1, further comprising:
recording replacement times of hot swapping hard disks after the backup data stored in the SD card are copied to the second hard disk.

5. The method according to claim 4, further comprising:
displaying a message for taking the SD card out through different lighting modes of light emitting diodes (LEDs) if the replacement times are recorded.

6. A storage medium having stored thereon instructions that, when executed by a processor of a digital video recorder, causes the processor to perform a method for performing data backup of the digital video recorder, the method comprising:
determining if a second safe mechanism key stored in a secure digital (SD) card is the same as a first safe mechanism key stored in the digital video recorder when the SD card is inserted in the digital video recorder;
changing a data storage path from a first hard disk of the digital video recorder to the SD card if the second safe mechanism key stored in the SD card is the same as the first safe mechanism key stored in the digital video recorder;
changing the data storage path from the SD card to a second hard disk when the second hard disk is installed in the digital video recorder; and
copying backup data stored in the SD card to the second hard disk.

7. The storage medium according to claim 6, wherein the safe mechanism key comprises an identification code and a cryptograph of the digital video recorder.

8. The storage medium according to claim 6, further comprising: storing data into the first hard disk of the digital video recorder under the condition that the SD card is not detected by the digital video recorder, or the second safe mechanism key stored in the SD card is not the same as the first safe mechanism key stored in the digital video recorder.

9. The storage medium according to claim 6, further comprising: recording replacement times of hot swapping hard disks after the backup data stored in the SD card are copied to the second hard disk.

10. The storage medium according to claim 9, further comprises: displaying a message for taking the SD card out through different lighting modes of light emitting diodes (LEDs) if the replacement times are recorded.

11. The storage medium according to claim 6, wherein the medium is selected from the group consisting of a hard disk drive, a compact disc, a digital video disc, and a tape drive.

12. A system for performing data backup of a digital video recorder, comprising:
a detecting module operable to detect if a secure digital (SD) card is inserted in the digital video recorder;
a determining module operable to determine if a second safe mechanism key stored in the SD card is the same as a first safe mechanism key stored in the digital video recorder when the SD card is detected by the digital video recorder;
a switching module operable to change a data storage path from a first hard disk of the digital video recorder to the SD card if the second safe mechanism key stored in the SD card is the same as the first safe mechanism key stored in the digital video recorder;
the switching module further operable to change the data storage path from the SD card to a second hard disk when the second hard disk is installed in the digital video recorder; and
a storing module operable to copy backup data stored in the SD card to the second hard disk.

13. The system according to claim 12, wherein the safe mechanism key comprises an identification code and a cryptograph of the digital video recorder.

14. The system according to claim 12, wherein the storing module further operable to: store data into the first hard disk of the digital video recorder under the condition that the SD card is not detected by the digital video recorder, or the second safe mechanism key stored in the SD card is not the same as the first safe mechanism key stored in the digital video recorder.

15. The system according to claim 12, further comprising: a recording module operable to record replacement times of hot swapping hard disks after the backup data stored in the SD card are copied to the second hard disk.

16. The system according to claim 15, wherein the switching module further operable to: display a message for taking the SD card out through different lighting modes of light emitting diodes (LEDs) if the replacement times are recorded.
